(19) United States
(12) Patent Application Publication
(10) Pub. No.: US 2021/0133851 A1
(43) Pub. Date: May 6, 2021

(54) PERSONALIZED CONTENT BASED ON INTEREST LEVELS

(71) Applicant: Airbnb, Inc., San Francisco, CA (US)

(72) Inventors: Xi Chen, Millbrae, CA (US); Teng Wang, Millbrae, CA (US); Dapeng Li, Mountain View, CA (US); Shike Mei, San Carlos, CA (US); Xingnan Xia, San Francisco, CA (US); Carlos Asensio Jimenez, San Francisco, CA (US); Ganesh Venkataraman, Mountain View, CA (US)

(21) Appl. No.: 16/675,768

(22) Filed: Nov. 6, 2019

(51) Int. Cl. G06Q 30/06; G06Q 30/02; G06K 9/62

(52) U.S. Cl. CPC G06Q 30/0631; G06K 9/6267; G06Q 30/0641; G06Q 30/0201

(57) ABSTRACT

Systems and methods are provided for providing personalized content based on interest levels determined using machine learning. An online marketplace system determines an interest profile for a client user using profile data of the client user as input into an interest extraction model. The online marketplace system selects a content item for the client user based on the interest profile and causes presentation of the content item to the client user via a channel that is separate from the online marketplace system. In response to receiving a request to access the online marketplace system originated from the content item, the online marketplace system selects product recommendations based on interest profile and the content item. The online marketplace system generates a personalized landing webpage including the product recommendations and causes presentation of the personalized landing webpage to the client user.

### BACKGROUND

Current online marketplaces enable users to purchase a variety of items and/or services listed for sale by the online marketplace. Content is often presented to users to encourage the users in purchasing the items and/or services offered for sale. For example, content describing items of interest may be presented to users prominently on the website of the online marketplace of through advertisements delivered to the users through other channels. This approach is often effective when used in relation to items that users purchase without much hesitation, such as frequently purchased items or low-price items. However, this approach is not as effective in relation to infrequently purchased or high price item that users spend a more time considering prior to finalizing a purchase. For example, users generally spend weeks or even months on research and planning prior to purchasing a vacation or a new car. Providing relevant and effective content in relation to these types of items is a challenge as users may be in different stages of the conversion process.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a block diagram illustrating an online marketplace system, according to some example embodiments.

FIG. 3 illustrates an example user interface displaying an example listing for an offered service, according to some example embodiments.

FIG. 4 is a block diagram illustrating a targeting system, according to some example embodiments.

FIG. 5 is a flowchart illustrating aspects of a method for providing personalized content based on interest levels determined using machine learning, according to some example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Systems and methods described herein relate to providing personalized content based on interest levels determined using machine learning. An online marketplace system hosts an online marketplace that includes listings posted to the online marketplace by listing users (e.g., hosts, suppliers, managers, owners) for services offered by the listing users. For example, the listings may describe the services offered by the listing users, such as accommodations, tours, transportation, and so forth. Client users (e.g., guest, clients) may use the online marketplace system to view the posted listings and reserve or “book” one or more of the listed services. For example, the listings may describe accommodations hosted by various listing users, such as apartments, houses, cabins, a camper, one or more rooms in an apartment or house, or the like, that can be reserved by client users. As another example, the online marketplace may provide listings for other services, such as experiences (e.g., local tours), car rental, flights, public transportation, and other transportation or activities related to travel, that can be booked by client users.

To book a listed service, a client user creates a user account with the online marketplace system. Each user account maintains profile data associated with its corresponding client user. For example, the profile data may include client user provided personal and demographic data, such as the client user's name, address, age, ethnicity, and so forth. The profile data may also include financial information, such as the client user's credit card information, which may be used to book and pay for services offered through the online marketplace system. The profile data may also include user interaction data describing a client user's interactions with the online marketplace system, such as data indicating listings viewed by the user, search queries entered by the user, listings liked by the user, listings booked by the user, and the like.

To encourage a client user to purchase services listed on the online marketplace system, the online marketplace system may present personalized content to the client user via other channels that are separate from the online marketplace system, as well as generate a personalized landing page for the client user when the client user accesses the online marketplace system. For example, the online marketplace may select and cause presentation of content items (e.g., advertisements) to the client users via one or more other channels that are separate from the online marketplace system. For example, the content items may be presented to the client user through a channel that communicates directly with the client user, such as via email or direct message. As another example, the content items may be presented to the client user through a third-party channel, such as an advertisement (e.g., banner advertisement) presented to the client user on a third-party website.

The online marketplace system may also generate a personalized landing page for the client user when the user accesses the online marketplace system. The landing page is a user interface presented to the client user when the user accesses the online marketplace system through the internet or use of a client-side application. The online marketplace system generates the personalized landing page to prominently present listings for services that are determined to be of interest to the client user. Accordingly, when the client user navigates to the online marketplace system website or accesses the online marketplace via a client-side application, the client user will be presented with a landing page including listings that are relevant and of interest to the user.

As explained earlier, current systems do not account for the client user's stage in the conversion process when selecting and presenting content. For example, current systems select content to present to a client user without consideration to whether the client user is in the initial research stages and perhaps undecided on whether to purchase a vacation or the later stages of the process in which the client user has already selected the destination, dates and budget for the vacation. Accordingly, the relevance of a content item to a given client user varies based on the client user's current stage in the purchasing process. For example, content related to ski rental may not be relevant to a client user that is undecided on whether to purchase a vacation, whereas the same content is likely to be relevant to a client user that has decided to purchase a vacation for the purposes of skiing. Likewise, content that generally advertises the relaxing nature of taking a vacation may not be of particular relevance to a client user that has already committed to purchasing a vacation for the purposes of skiing, whereas the same content may be relevant to a client user that is undecided on whether to purchase a vacation.

The online marketplace system of the present disclosure provides an improvement to these previous systems by providing personalized content to a client user based on a determined interest level profile of the client user. The determined interest level profile describes a current interest level of the client user in relation to the purchasing process based on one or more predetermined interest categories. For example, the interest categories may include one or more of destination, purpose, time, and budget.

The client user's interest profile is defined by a set of interest classifiers that includes individual interest classifiers assigned for each classification category. The interest classifier assigned for a given category indicates the respective client user's level of interest for the given classification category. For example, a client user in the early stages of the purchasing process that is undecided on destination, dates, purpose and budget of the vacation may be assigned an interest classifier of “undecided” for each classification category. As another example, a client user that has decided to take a vacation for the purposes of skiing may be assigned an interest classifier of “skiing” for the interest category “purpose,” while being assigned “undecided” for the interest categories “destination,” “time,” and “budget.” As the client user progresses through the purchase process, the interest classifiers assigned to the client user are updated to reflect changes in the client user's interest profile based on the interest categories.

The online marketplace system determines the interest classifiers for a client user based on the client's user's profile data. For example, the online marketplace system uses the client user's profile data as input into an interest extraction model that assigns an interest classifier for a given interest category for a client user. The interest extraction model is a machine learning model that has been trained using labeled training profile data from multiple user accounts of the online marketplace system. In one example, the labeled training profile data is profile data from user accounts that has been reviewed and labeled with an interest classifier by human reviewers.

The online marketplace system uses separately trained interest extraction models for each interest category. For example, the online marketplace system may use one interest extraction model trained to assign an interest classifier for the interest category “destination,” another interest extraction model trained to assign an interest classifier for the interest classifier “time,” and so on.

The online marketplace system uses the interest profile for a client user to select content items to be presented to the user. For example, the online marketplace system uses a content recommendation model trained assign probability values indicating an estimated likelihood that a content item is relevant for the client user, given the client user's interest profile. Accordingly, the online marketplace system may use the client user's interest profile as input in the content recommendation model, which assigns probability values for a set of content items. The online marketplace system then selects a content item for the client user based on the probability values.

Similarly, the online marketplace system may generate a personalized landing page for a client user based on the client user's interest profile. For example, the online marketplace system uses a product recommendation model trained to assign probability values indicating an estimated likelihood that a product recommendation is relevant for the client user, given the client user's interest profile. Accordingly, the online marketplace system uses the client user's interest profile as input in the product recommendation model, which assigns probability values for a set of products. The online marketplace system then selects product recommendations based on the probability values. The online marketplace system includes the product recommendations in the personalized landing page generated for the client user.

In some embodiments, the product recommendation model is further trained to determine probability values based on the content items selected by the client user to access the online marketplace system. For example, the online marketplace system maintains a record of the content items that have been presented to the client user along with data indicating whether the client user interacted with the content item, such as by clicking on the content item to be forwarded to a landing page of the online marketplace system. In this type of embodiment, the online marketplace system uses the client user's interest profile and data indicating the content items selected by the user as input into the product recommendation model when generating a personalized landing page for the client user.

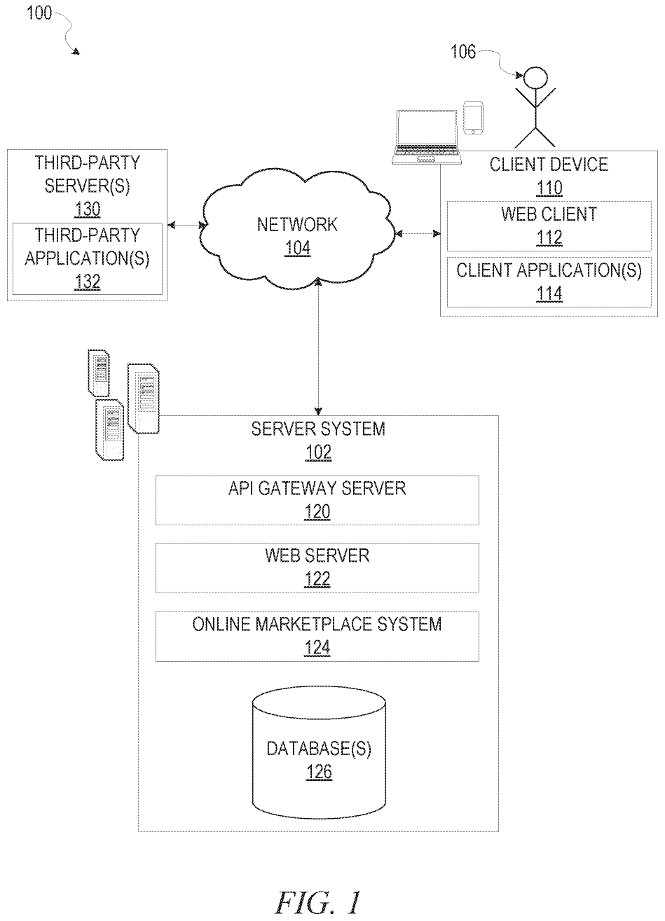

FIG. 1 is a block diagram illustrating a networked system 100, according to some example embodiments. As shown, the system 100 includes a client device 110. The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronic system, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, Global Positioning System (GPS) devices, and so forth. The client device 110 may be a device of a user that is used to request and receive reservation information, accommodation information, and so forth, associated with travel. The client device 110 may also be a device of a user that is used to post and maintain a listing for a service, request and receive reservation information, guest information, and so forth. Although the system 100 is shown as including only a single client device 106, this is only for ease of explanation and is not meant to be limiting. The system 100 may include any number of client device 106.

One or more users 106 (e.g., listing user, client user) may be a person, a machine, or other means of interacting with the client device 110. In example embodiments, the user 106 may not be part of the system 100 but may interact with the system 100 via the client device 110 or other means. For instance, the user 106 may provide input (e.g., voice input, touch screen input, alphanumeric input, etc.) to the client device 110 and the input may be communicated to other entities in the system 100 (e.g., third-party servers 130, a server system 102, etc.) via a network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 may further include a network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WI-FI network, a WiMax network, another type of network, or a combination of two or more such networks.

The client device 110 may access the various data and applications provided by other entities in the system 100 via a web client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, a messaging application, an electronic mail (email) application, an e-commerce site application, a mapping or location application, a reservation application, and the like.

In some embodiments, one or more client applications 114 may be included in a given one of the client devices 110 and configured to locally provide the user interface and at least some of the functionalities, with the client application 114 configured to communicate with other entities in the system 100 (e.g., third-party servers 130, the server system 102, etc.), on an as-needed basis, for data and/or processing capabilities not locally available (e.g., to access reservation or listing information, to request data, to authenticate a user 106, to verify a method of payment). Conversely, one or more client applications 114 may not be included in the client device 110, and then the client device 110 may use its web browser to access the one or more applications hosted on other entities in the system 100 (e.g., third-party servers 130, the server system 102).

The system 100 may further include one or more third-party servers 130. The one or more third-party servers 130 may include one or more third-party application(s) 132. The one or more third-party application(s) 132, executing on the third-party server(s) 130, may interact with the server system 102 via a programmatic interface provided by an application programming interface (API) gateway server 120. For example, one or more of the third-party applications 132 may request and utilize information from the server system 102 via the API gateway server 120 to support one or more features or functions on a website hosted by a third party or an application hosted by the third party. For example, the third-party website or application 132, may provide various functionality that is supported by relevant functionality and data in the server system 102, such as presenting content items (e.g., advertisements) selected by the server system 102.

The server system 102 may provide server-side functionality via the network 104 (e.g., the Internet or a wide area network (WAN)) to one or more third-party servers 130 and/or one or more client devices 110. The server system 102 may be a cloud computing environment, according to some example embodiments. The server system 102, and any servers associated with the server system 102, may be associated with a cloud-based application, in one example embodiment.

In one example, the server system 102 provides server-side functionality for an online marketplace system 124. The online marketplace system 124 may facilitate an online marketplace in which listing users may post listings for services offered by the listing users. For example, the listings may describe the services offered by the listing users, such as accommodations, tours, transportation, and so forth. Client users (e.g., guest, clients, etc.) may use the online marketplace to view the posted listings and reserve or “book” one or more of the listed services. For example, the listings may describe accommodations hosted by various listing users, such as apartments, houses, cabins, a camper, one or more rooms in an apartment or house, and the like, that can be reserved by client users. As another example, the online marketplace may provide listings for other services, such as experiences (e.g., local tours), car rental, flights, public transportation, and other transportation or activities related to travel, that can be booked by client users.

The server system 102 may include the API gateway server 120, a web server 122, and an online marketplace system 124, that may be communicatively coupled with one or more databases 126 or other forms of data store.

The one or more databases 126 may be one or more storage devices that store data related to the reservation system 124 and other systems or data. The one or more databases 126 may further store information related to third-party servers 130, third-party applications 132, client devices 110, client applications 114, users 106, and so forth. The one or more databases 126 may be implemented using any suitable database management system such as MySQL, PostgreSQL, Microsoft SQL Server, Oracle, SAP, IBM DB2, or the like. The one or more databases 126 may include cloud-based storage, in some embodiments.

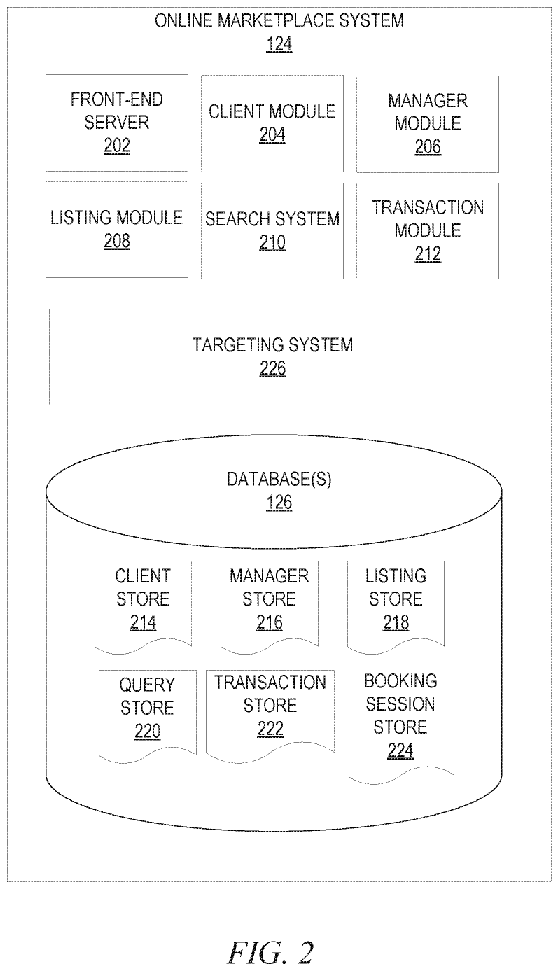

The online marketplace system 124 may manage resources and provide back-end support for third-party servers 130, third-party applications 132, client applications 114, and so forth, which may include cloud-based applications. The online marketplace system 124 may facilitate an online marketplace for listed services. For example, the online marketplace system 124 may provide functionality for posting and managing listings related to services, such as accommodation listings, activity listings, etc., to the online marketplace, as well as functionality for viewing, booking and otherwise reserving the services provided by the listings posted to the online marketplace. Further details related to the online marketplace system 124 are shown in FIG. 2 and described in the accompanying text.

FIG. 2 is a block diagram illustrating an online marketplace system 124, according to some example embodiments. The online marketplace system 124 comprises a front-end server 202, a client module 204, a manager module 206, a listing module 208, a search system 210, a transaction module 212, and a targeting system 226. The one or more database(s) 126 include a client store 214, a manager store 216, a listing store 218, a query store 220, a transaction store 222, and a booking session store 224. The online marketplace system 124 may also contain different and/or other systems or modules that are not described herein.

The online marketplace system 124 may be implemented using a single computing device or a network of computing devices, including cloud-based computer implementations. The computing devices may be server-class computers including one or more high-performance computer processors and random-access memory, which may run an operating system such as Linux or the like. The operations of the online marketplace system 124 may be controlled either through hardware or through computer programs installed in non-transitory computer-readable storage devices such as solid-state devices or magnetic storage devices and executed by the processors to perform the functions described herein.

The front-end server 202 includes program code that allows a client device 110 to communicate with the online marketplace system 124. The front-end server 202 may utilize the API gateway server 120 and/or the web server 122 shown in FIG. 1. The front-end server 202 may include a web server hosting one or more websites accessible via a hypertext transfer protocol (HTTP), such that user agents (e.g., a web browser software application), may be installed on the client device 110 and send commands to and receive data from the online marketplace system 124. The front-end server 202 may also utilize the API gateway server 120 that allows software applications installed on the client device 110 to transmit requests to the API gateway server 120 to send commands to and receive data from the online marketplace system 124. The front-end server 202 further includes program code to route commands and data to the other components of the online marketplace system 124 to carry out the processes described herein and respond to the client device 110 accordingly.

The client module 204 comprises program code that allows client users to manage their interactions with the online marketplace system 124 and executes processing logic for client user-related information that may be requested by other components of the online marketplace system 124. Each client user is represented in the online marketplace system 124 by a client object having a unique user identifier (ID) and user profile, both of which are stored in the client store 214.

The user profile includes a number of client user-related attribute fields that may include a profile picture and/or other identifying information, a geographical location, a calendar, and so forth. The client user's geographical location is either the client user's current location (e.g., based on information provided by the client device 110), or the client user's provided home address, neighborhood, city, state, or country of residence. The user profile may also include also include user interaction data describing a client user's interactions with the online marketplace system, such as data indicating listings viewed by the user, search queries entered by the user, listings liked by the user, etc.

The client module 204 provides code for a client user to set up and modify the client user's profile. The online marketplace system 124 allows each client user to exchange communications, request transactions, and perform transactions with other users (e.g., client users, listing users).

The manager module 206 comprises program code that provides a user interface that allows listing users to manage their interactions and listings with the online marketplace system 124 and executes processing logic for listing user-related information that may be requested by other components of the reservation system 124. Each listing user is represented in the reservation system 124 by a manager object having a unique listing user ID and listing user profile, both of which are stored in the manager store 216.

The listing user profile is associated with one or more listings owned or managed by the listing user and includes a number of listing user attributes including transaction requests and a set of listing calendars for each of the listings managed by the listing user.

The manager module 206 provides code for listing users to set up and modify the listing user's profile listings. A user 106 of the reservation system 124 can be both a client user and a listing user. In this case, the user 106 will have a profile entry in both the client store 214 and the manager store 216 and be represented by both a client object and a manager object. The online marketplace system 124 allows the listing users to exchange communications, respond to requests for transactions, and conduct transactions with other listing users.

The listing module 208 comprises program code enabling listing users to generate and post listings for offered services to the online marketplace facilitated by the online marketplace system 124. Once posted, the listings can be booked, purchased and/or otherwise reserved by client users. The listing module 208 is configured to receive data describing the service offered by the listing from a listing user, such as data describing the specific service being offered; a timeframe of its availability including one or more of the start date, end date, start time, and an end time; a price; a geographical location; images and description that characterize the service; and any other relevant information. For example, a listing offering an accommodation may include a description of the type of accommodation (e.g., house, apartment, room, sleeping space, or other), a representation of its size (e.g., square footage, or number of rooms), the dates that the accommodation is available, and a price (e.g., per night, per week, per month, etc.). The listing module 208 allows a listing user 106 to include additional information about the service, such as videos, photographs, and other media.

The geographical location associated with the listing identifies the region, complete address, neighborhood, city, and/or country in which the service is offered. The listing module 208 is also capable of converting one type of location information (e.g., mailing address) into another type of location information (e.g., country, state, city, and neighborhood) using externally available geographical map information.

The price of the listing is the amount of money a client user is requested to pay in order to complete a transaction for the listed service. The price may be specified as an amount of money per day, per week, per day, per month, and/or per season, or per another interval of time specified by the listing user. Additionally, the price may include additional charges such as cleaning fees, pet fees, service fees, and taxes, or the listing price may be listed separately from additional charges.

Each listing is represented in online marketplace system 124 by a listing object, which includes the listing information as provided by the listing user and a unique listing ID, both of which are stored in the listing store 218. Each listing object is also associated with the manager object for the listing user that posted the listing.

Each listing is associated with a number of listing features that describe the listing and/or service offered by the listing, which may be stored in the listing store 218 and associated with the corresponding listing object. For example, listing features that describe the provided services may include a price to purchase and/or reserve the provided service, one or more fees (e.g., cleaning fee, additional guest fee, etc.) associated with purchasing and/or reserving the provided service, discounts associated with the service, a number of bedrooms or beds, a percentage of time that the service is booked or occupied, a geographic location associated with the provided, service, etc. Listing features that describe the listing services may include a listing view (e.g., number of views by client users), a number of images included in the listing, an amount of descriptive data provided in the listing, a popularity rank of the listing, etc.

Each listing object has an associated listing calendar. The listing calendar stores the availability of the listing for each time interval in a time period (each of which may be thought of as an independent item of time-expiring inventory), as specified by the listing user or determined automatically (e.g., through a calendar import process). For example, a listing user may access the listing calendar for a listing, and manually indicate the time intervals for which the service offered by the listing is available for transaction by a client user, which time intervals are blocked as not available by the listing user, and which time intervals are already in transaction (e.g., booked) for a client user. In addition, the listing calendar continues to store historical information as to the availability of the listing identifying which past time intervals were booked by client users, blocked, or available. Further, the listing calendar may include calendar rules (e.g., the minimum and maximum number of nights allowed for the inventory, a minimum or maximum number of nights needed between bookings, a minimum or maximum number of people allowed for the inventory, etc.). Information from each listing calendar is stored in the listing store 218.

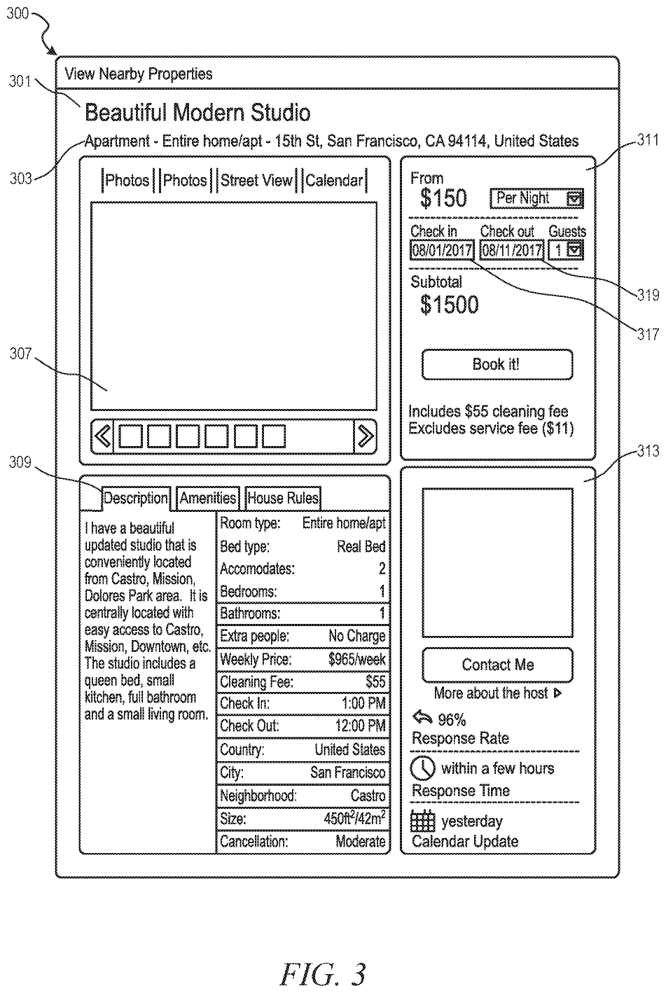

FIG. 3 illustrates an example user interface 300 for a description of a listing for an offered service (e.g., an apartment in San Francisco) posted to an online marketplace. The example listing shown in FIG. 3 is for accommodation services in San Francisco. In other examples, the listing could be for services such as a tour, local experience, transportation, or other service. The listing may include a title 301 and a brief description 303 of the service. The listing may further include photos of the service, maps of the area or location associated with the service, a street view of the service, a calendar of the service, and so forth, which may be viewed in area 307. The listing may include a detailed description 309, pricing information 311, and the listing user's information 313. The listing may further allow a client user to select a date range for booking the service by entering or choosing specific check-in date 317 and check-out date 319.

Returning to FIG. 2, the search system 210 comprises program code configured to enable client users to search listings posted to the online marketplace based on search parameters provided by the client users. This functionality aids client users in finding listings that are relevant to the client user's needs. For example, a client user may provide search parameters such as defining a particular location for the services (e.g., San Francisco), desired dates that the service is needed (e.g., 6/10-6/17), the type of service needed (e.g., house rental, car rental, tour), a desired price range for the services, and so forth. The search system 210 uses the provided search parameters to execute a search query of the listing store in which the search system 210 identifies listings posted to the online marketplace that meet the client user's provided search parameters. For example, the search system 210 may identify listings providing services that are within the specified geographic location, are offered within the specified price range, include a specified number of rooms, and so forth.

Search queries are saved as query objects stored by the online marketplace system 124 in the query store 220. For example, data associated with the search query, such as its search query features may be stored in the query store 220 and associated with the query object. Each search query is associated with a number of query features that describe the search query and/or the client user that caused the search query. For example, the query features may include the search parameters of the search query, such as a specified, location, price range, dates, type of service, etc. The query features may also include data stored in the client store 214 that describes the client user. For example, the query features may include such the location, age, sex, income, and so forth, of the client user, as well as historical purchase and/or reservation data of the client user, such as data describing previous listings that the client user purchased and/or reserved (e.g., price ranges, listing features).

In addition to the query features of the search query, data describing the listings identified as a result of the search query, the listings selected by the client user, the listing not selected by the client user, and so forth, may also be stored in the query store 220 and associated with the query object. For example, upon a client user providing input selecting a listing to more carefully review for possible transaction, the search system 210 records the selection in the query store 220.

The transaction module 212 comprises program code configured to enable client users to purchase, book, or reserve services provided by a listing. In operation, the transaction module 212 receives a transaction request from a client to book the offered service. A transaction request may be a standardized request form that is sent by the client user's client device 110, and which may be either modified, accepted or denying by the listing user. Modifications to a received request may include, for example, changing the date, price, or time/date range requested by the client user.

If the listing user accepts the request (or the client user accepts the proposed alternative), then the transaction module 212 updates an acceptance status associated with the request and the listing to indicate that the request was accepted. The client calendar and the listing calendar are also updated to reflect that the service offered by the listing has been transacted on for a particular time interval. Other modules not specifically described herein allow the client user to complete payment and the manager to receive payment.

The transaction module 212 may further comprise code configured to enable client users to instantly book services offered by a listing, whereby the online marketplace system 124 books or reserves the service upon receipt of the request from the client user.

The transaction store 222 stores requests made by clients. Each request is represented by a request object. The request includes a timestamp, a requested start time, and a requested duration or reservation end time. Because the acceptance of a booking by a manager is a contractually binding agreement with the client that the manager will provide the time-expiring inventory to the client at the specified times, all the information that the manager needs to approve such an agreement is included in the request. A manager response to a request comprises a value indicating acceptance or denial and a timestamp. Other models may allow for instant booking, as mentioned above.

The transaction module 212 may also provide listing users and client users with the ability to exchange informal requests to transact. Informal requests are not sufficient to be binding upon the client user or listing user if accepted, and in terms of content, may vary from mere communications and general inquiries regarding the availability of inventory, to requests that fall just short of whatever specific requirements the online marketplace system 124 sets forth for formal transaction requests. The transaction module 212 may also store informal requests in the transaction store 222, as both informal and formal requests provide useful information about the demand for the listed services.

The booking session store 224 stores booking session data for all booking sessions performed by client users. Booking session data may include details about a listing that was booked and data about one or more other listings that were viewed (or seriously considered) but not booked by the client user before booking the listing. For example, once a listing is booked, the transaction module 212 may send data about the listing or the transaction, viewing data that was recorded for the booking session, and so forth, to be stored in the booking session store 224. The transaction module 212 may utilize other modules or data stores to generate booking session data to be stored in the booking session store 224.

The targeting system 226 comprises program code configured to provide client users with personalized content. To encourage a client user to purchase services listed on the online marketplace system 124, the targeting system 226 presents personalized content to the client user via other channels that are separate from the online marketplace system 124, as well as generates a personalized landing page for the client user when the client user accesses the online marketplace system 124. For example, the targeting system 226 selects and causes presentation of content items (e.g., advertisements) to the client users via one or more other channels that are separate from the online marketplace system 124. For example, the content items may be presented to the client user through a channel that communicates directly with the client user, such as via email or direct message. As another example, the content items may be presented to the client user through a third-party channel, such as an advertisement (e.g., banner advertisement) presented to the client user on a third-party website or third-party application 132 facilitated by a third-party server 130.

The targeting system 226 also generates a personalized landing page for the client user when the user accesses the online marketplace system 124. The landing page is a webpage presented to the client user when the user accesses the online marketplace system 124 through the internet or use of a client-side application. The targeting system 226 generates the personalized landing page to prominently present listing for services that are determined to be of interest to the client user. Accordingly, when the client user navigates to the online marketplace system 124 website or accesses the online marketplace via a client-side application 114, the client user will be presented with a landing page including listings that are relevant and of interest to the user.

As explained earlier, current systems do not account for the client user's stage in the conversion process when selecting and presenting content. For example, current systems select content to present to a client user without consideration to whether the client user is in the initial research stages and perhaps undecided on whether to purchase a vacation or the later stages of the process in which the client user has already selected the destination, dates and budget for the vacation. Accordingly, the relevance of a content item to a given client user varies based on the client user's current stage in the purchasing process. For example, content related to ski rental may not be relevant to a client user that is undecided on whether to purchase a vacation, whereas the same content is likely to be relevant to a client user that has decided to purchase a vacation for the purposes of skiing. Likewise, content that generally advertises the relaxing nature of taking a vacation may not be of particular relevance to a client user that has already committed to purchasing a vacation for the purposes of skiing, whereas the same content may be relevant to a client user that is undecided on whether to purchase a vacation.

The targeting system 226 provides an improvement to these previous systems by providing personalized content to a client user based on a determined interest level profile of the client user. The determined interest level profile describes a current interest level of the client user in relation to the purchasing process based on one or more predetermined interest categories. For example, the interest categories may include one or more of destination, purpose, time, and budget. Providing personalized content based on a determined interest level profile reduces the number of irrelevant content transmitted, thereby reducing the number of electronic communications transmitted between devices. As a result, overall computing resources are reduced, which provides an improvement to the perceived functioning of the computing devices.

The client user's interest profile is defined by a set of interest classifiers that includes individual interest classifiers assigned for each classification category. The interest classifier assigned for a given category indicates the respective client user's level of interest for the given classification category. For example, a client user in the early stages of the purchasing process that is undecided on destination, dates, purpose and budget of the vacation may be assigned an interest classifier of “undecided” for each classification category. As another example, a client user that has decided to take a vacation for the purposes of skiing may be assigned an interest classifier of “skiing” for the interest category “purpose,” while being assigned “undecided” for the interest categories “destination,” “time,” and “budget.” As the client user progresses through the purchase process, the interest classifiers assigned to the client user are updated to reflect changes in the client user's interest profile based on the interest categories.

The targeting system 226 determines the interest classifiers for a client user based on the client's user's profile data stored in the databases 126, such as the client store 214, query store 220, transaction store 222, etc. For example, the targeting system 226 uses the client user's profile data as input into an interest extraction model that assigns an interest classifier for a given interest category for a client user. The profile data may include client user provided personal and demographic data, such as the client user's name, address, age, ethnicity, and so forth. The profile data may also include financial information, such as the client user's credit card information, which may be used to book and pay for services offered through the online marketplace system. The profile data may also include user interaction data describing a client user's interactions with the online marketplace system, such as data indicating listings viewed by the user, search queries entered by the user, listings liked by the user, listings booked by the user, and the like. The interest extraction model is a machine learning model that has been trained using labeled training profile data from multiple user accounts of the online marketplace system. The labeled training profile data is profile data from user accounts that has been reviewed and labeled with an interest classifier by human reviewers.

The targeting system 226 uses separately trained interest extraction models for each interest category. For example, the targeting system 226 may use one interest extraction model trained to assign an interest classifier for the interest category “destination,” another interest extraction model trained to assign an interest classifier for the interest classifier “time,” and so on.

The targeting system 226 uses the interest profile for a client user to select content items to be presented to the client user. For example, the targeting system 226 may use a content recommendation model trained to assign probability values indicating an estimated likelihood that a content item is relevant to the client user, given the client user's interest profile. Accordingly, the targeting system 226 may use the client user's interest profile as input in the content recommendation model, which assigns probability values for a set of content items. The targeting system 226 then selects a content item for the client user based on the probability values.

Similarly, the targeting system 226 may select product recommendations to include in a personalized landing page for a client user based on the client user's interest profile. For example, the targeting system 226 may use a product recommendation model trained to assign probability values indicating an estimated likelihood that a product recommendation is relevant for the client user, given the client user's interest profile. A product recommendation may be any type of service listed by the online marketplace system 124, such as lodging, activities, vehicle rental, airfare, and so forth. Accordingly, the targeting system 226 may use the client user's interest profile as input in the product recommendation model, which assigns probability values for a set of products. The targeting system 226 then selects product recommendations based on the probability values, which are included in the personalized landing page generated for the client user.

In some embodiments, the product recommendation model is further trained to determine probability values based on the content items selected by the client user to access the online marketplace system 124. For example, the targeting system 226 may maintain a record of the content items that have been presented to the client user along with data indicating whether the client user interacted with the content item, such as by clicking on the content item to be forwarded to a landing page of the online marketplace system 124. In this type of embodiment, the targeting system 226 may use the client user's interest profile and data indicating the content items selected by the user as input into the product recommendation model when generating a personalized landing page for the client user.

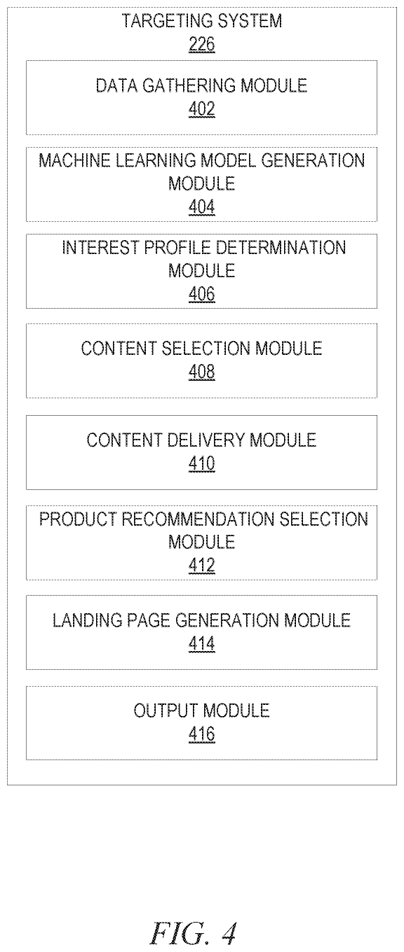

FIG. 4 is a block diagram illustrating a targeting system 226, according to some example embodiments. The targeting system 226 comprises a data gathering module 402, machine learning model generation module 404, an interest profile determination module 406, a content selection module 408, a content delivery module 410, a product recommendation selection module 412, a landing page generation module 414, and an output module 416.

The targeting system 226 may be implemented using a single computing device or a network of computing devices, including cloud-based computer implementations. The computing devices may be server-class computers including one or more high-performance computer processors and random-access memory, which may run an operating system such as Linux or the like. The operations of the targeting system 226 may be controlled either through hardware or through computer programs installed in non-transitory computer-readable storage devices such as solid-state devices or magnetic storage devices and executed by the processors to perform the functions described herein.

The data gathering module 402 gathers data used by the various modules of the targeting system 226. For example, the data gathering module 402 communicates with and gathers data from the databases 126, including the client store 214, listing store 218, query store 220, transaction store 222, and so forth. The data gathered by the data gathering module 402 may include user profile data, such as client user provided personal and demographic data (e.g., name, address, age, ethnicity, etc.), financial information (e.g., client user's credit card information), and user interaction data describing a client user's interactions with the online marketplace system (e.g., listing viewed by the user, search queries entered by the user, listings liked by the user, etc.).

The machine learning model generation module 404 generates machine learning models used by the targeting system 226. For example, the machine learning model generation module 404 generates interest extraction models for various interest categories, a content recommendation model, and a product recommendation model.

As explained earlier, current systems do not account for the client user's stage in the conversion process when selecting and presenting content. For example, current systems select content to present to a client user without consideration to whether the client user is in the initial research stages and perhaps undecided on whether to purchase a vacation or the later stages of the process in which the client user has already selected the destination, dates and budget for the vacation. Accordingly, the relevance of a content item to a given client user varies based on the client user's current stage in the purchasing process.

The targeting system 226 provides an improvement to these previous systems by providing personalized content to a client user based on a determined interest level profile of the client user. The determined interest level profile describes a current interest level of the client user in relation to the purchasing process based on one or more predetermined interest categories. The targeting system 226 uses the client user's interest profile to select content items to present to the user, as well as to select product recommendations to include in a personalized landing page for the client user.

The client user's interest profile is defined by a set of interest classifiers that includes individual interest classifiers assigned for various classification categories. The interest classifier assigned for a given category is selected from a set of predetermined interest classifiers for the given category and indicates the respective client user's level of interest for the given classification category. As an example, the set of predetermined interest classifiers for the interest category “destination” may include interest classifiers indicating how far the user is in the process of choosing a destination. For example, the set of predetermined interest classifiers may include the interest classifier “undecided” indicating that the client user has not made any decision regarding the destination of their vacation. The set of predetermined interest classifiers may include the interest classifiers “warm weather” or “cold weather” to indicate that the client user has narrowed their decision to a general type of destination. The set of predetermined interest classifiers may include the interest classifiers “Hawaii,” “France,” or “Paris” to indicate that the client user has selected a more specific destination.

The targeting module 226 determines the interest classifiers for a client user by using the client user's profile data as input into an interest extraction model that outputs a probability value for each interest classifier from the set of predetermined interest classifiers. Each probability value indicates an estimated likelihood that the interest classifier properly indicates the client user's level of interest for the given classification category. The targeting system 226 uses the probability values to select and assign an interest classifier for a given interest category to a client user.

The machine learning model generation module 404 generates interest extraction models using labeled training profile data from multiple user account of the online marketplace system 124. The labeled training profile data is profile data from user accounts that has been reviewed and labeled with an interest classifier by human reviewers. That is, the human labelers review the training profile data and select interest classifiers for to the training profile data for one or more different interest classifiers. The training profile data is labeled with the interest classifiers selected by the human labelers. In some embodiments, multiple human labelers may review the training profile data and assign interest classifiers. In this type of embodiments, the training profile data may be labeled with the interest classifies that were selected most commonly by the human labelers.

The machine learning model generation module 404 trains the interest extraction model for each interest categories based on the interest classifier for the interest category assigned to the training profile data by the human reviewers. For example, the machine learning model generation module 404 generates an interest extraction model for the interest category “destination” based on the interest classifiers assigned to the training profile data for the interest category “destination.” The machine learning model generation module 404 generates an interest extraction model for each interest category based on training profile data and the interest classifiers assigned to the training profile data for each respective interest category.

The machine learning model generation module 404 generates a content item selection model used to select content items for the client user based on the client user's interest profile (e.g., set of interest classifiers for each interest category) and a product recommendation model used to select content recommendations for a client user based on the client user's interest profile and content items presented/selected by the client user. The content item selection model selects content items for a client user from a library of available content items based on a client user's interest profile.

The machine learning model generation module 404 trains the content item selection model using labeled training data and/or historical interaction data. The labeled training data may include training interest profiles that have been labeled by human reviewers to indicate content items best suited for the interest profile. The historical interaction data includes data indicating content items previously presented to client users, the interest profiles of the client users, and interactions performed by the client users in response to being presented the content items.

The resulting content item selection model receives a client user's interest profile as input and outputs probability values for content items from the library of available content items. Each probability value indicates an estimated likelihood that the corresponding content item will be successful in eliciting a desired response from the client user, such as the client user selecting the content item to access the online marketplace system 124 website, booking a vacation, completing a purchase, and so forth. The targeting module 226 selects content items to present to a client user based on the probability values assigned by the content item selection model.

The product recommendation model selects product recommendations for a client user from a library of available product recommendations based on a client user's interest profile and content items presented and/or selected by the client user. The machine learning model generation module 404 trains the product recommendation model based on labeled training data and/or historical interaction data. The labeled training data may include training interest profiles and corresponding content items that have been labeled by human reviewers to indicate product recommendations best suited for a client user with the interest profile that has been presented with and/or interacted with the corresponding content items. The historical interaction data includes data indicating product recommendations previously presented to client users in a personalized landing page, the interest profiles of the client users, content items presented to and/or interacted with by the client users, product recommendations presented to the client users, and interactions performed by the client users in response to being presented with product recommendations.

The resulting product recommendation selection model receives a client user's interest profile and content items presented to and/or interacted with by the client user as input and outputs probability values for product recommendations from the library of available product recommendations. Each probability value indicates an estimated likelihood that the corresponding product recommendation will be successful in eliciting a desired response from the client user, such as the client user selecting the product recommendation or purchasing the corresponding product. The targeting module 226 selects product recommendations to include in a personalized landing page generated for a client user based on the probability values assigned by the product recommendation selection model.

The interest profile determination module 406 determines the interest profile for a client user. For example, the interest profile determination module 406 uses profile data for the client user as input into the set of interest extraction models generated by the machine learning model generation module 404. That is, the interest profile determination module 406 uses the client user's profile data as input into the interest extraction model for each interest category.

Using the profile data as input in an input extraction model results in a set of probability values indicating the estimated likelihood that each predetermined interest classifier for the interest category properly classifies the client user's interest level in the interest category. The interest profile determination module 406 uses the resulting probability values to select an interest classifier to assign to the client user for the interest category. For example, the interest profile determination module 406 selects the interest classifier with the highest assigned probability value.

The interest profile determination module 406 determines the interest profile for a client user based on a time schedule and/or in response to detecting certain events or activity. This includes initially determining the interest profile for the client user as well as determining an updated interest profile for the client user. For example, the interest profile determination module 406 may determine the interest profile for the client user based on a time schedule, such as every day, 2 days, week, and so forth. As another example, the interest profile determination module 406 may determine the interest profile of the client user in response to the client user performing certain actions, such as accessing the online marketplace system 124 website, selecting content items, and the like.

The content selection module 408 selects content items to present to a client user based on the client user's interest profile. A content item is any type of content meant to encourage the client user to purchase or book services listed by the online marketplace system 124. For example, the content items may be banner advertisements, images, videos, audio, and the like, that encourage the user to purchase or book services listed by the online marketplace system 124.

The content selection module 408 selects content items from a library of available content items. The content items included in the library of available content items may be of varying levels of specificity. For example, some content items may be general in nature such that they encourage the client user to book a vacation generally without identifying a specific vacation destination, dates, product, and so forth. An example of this type of content item may generally discuss or promote vacations as being fun or relaxing. Some content items may be more specific in nature such that that they encourage a client user to purchase a specific product or service, such as by identifying a specific destination, dates, hotel, activity, or the like.

The content selection module 408 selects content items for a client user based on the client user's interest profile. For example, the content selection module 408 uses the client user's interest profile as input into a content recommendation model. The content recommendation model outputs probability values for content items in the content item library based on the input interest profile. Each probability value indicates an estimated likelihood that the corresponding content item will be successful in eliciting a desired response from the client user, such as the client user selecting the content item to access the online marketplace system 124 website, booking a vacation, completing a purchase, and the like.

The content delivery module 410 causes presentation of the content items selected by the content selection module 408 to the client user. For example, the content delivery module 410 causes the content items to be presented to the client users via one or more other channels that are separate from the online marketplace system 124. For example, the content delivery module 410 may transmit a content item to a client user through a channel that communicates directly with the client user, such as via email or direct message. As another example, the content delivery module 410 may present a content item to the client user through a third-party channel, such as an advertisement (e.g., banner advertisement) presented to the client user on a third-party website.

The content items may be interactive such that a client user may interact with the content item to be directed to the online marketplace system 124 website. For example, the content item may include a selectable portion, which the client user may click, tap or otherwise actuate to cause the client user's client device 110 to navigate to a landing webpage of the online marketplace system 124. As explained earlier, the landing provide to the client user may be personalized to include product recommendations selected for the client user.

The product recommendation selection module 412 selects product recommendations to include in a personalized landing page for a client user. A product recommendation is a service associated with a listing posted to the online marketplace system 124. For example, a product recommendation may be lodging, travel, activity, or the like, that a client user may book through the online marketplace system 124.

The product recommendation selection module 412 selects product recommendations for a client user from a library of available product recommendations based on a client user's interest profile and content items presented and/or selected by the client user. The product recommendation selection module 412 uses the client user's interest profile and content items presented and/or selected by the client user as input into a product recommendation model that outputs probability values for product recommendations from the library of available product recommendations. Each probability value indicates an estimated likelihood that the corresponding product recommendation will be successful in eliciting a desired response from the client user, such as the client user selecting the product recommendation or purchasing the corresponding product. The product recommendation selection module 412 selects product recommendations to include in the personalized landing page generated for the client user based on the probability values assigned by the product recommendation selection model. For example, the product recommendation selection module 412 selects one or more product recommendations with the highest probability values. As another example, the product recommendation selection module 412 may select one or more product recommendations from varying product categories (e.g., lodging, activities, travel, etc.) that have the highest probability values for that given product category.

The landing page generation module 414 generates a personalized landing page for a client user based on the product recommendations selected by the product recommendation selection module 412. The landing page is a webpage presented to the client user when the user accesses the online marketplace system 124 website through the internet or use of a client-side application 114. The landing page generation module 414 generates the personalized landing page to prominently present listings for the product recommendations selected by the product recommendation selection module 412. Accordingly, when the client user navigates to the online marketplace system 124 website or accesses the online marketplace via a client-side application 114, the client user will be presented with the personalized landing page including listings that are relevant and of interest to the user.

The output module 416 provides the generated personalized landing page to the client user. For example, the output module 416 transmits code defining the personalized landing page to the client user's client device 110. The client user's client device 110 uses the received code to cause presentation of the landing page to the client user. For example, the personalize landing page is presented as a webpage generated by the web client 112 or as an initial page presented by the client application 114.

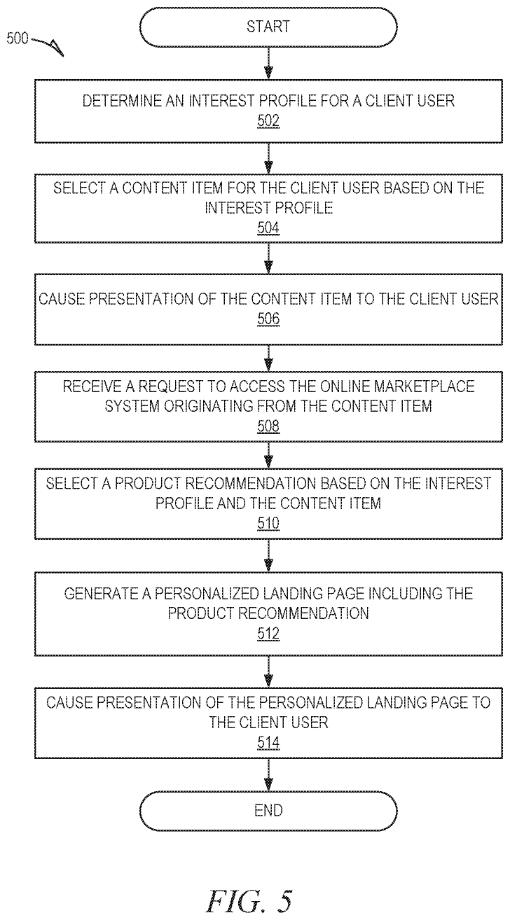

FIG. 5 is a flowchart illustrating aspects of a method 500 for providing personalized content based on interest levels determined using machine learning, according to some example embodiments. For illustrative purposes, the method 500 is described with respect to the networked system 100 of FIG. 1, the online marketplace system 124 of FIG. 2, and the targeting system 226 of FIG. 4. It is to be understood that the method 500 may be practiced with other system configurations in other embodiments.

At operation 502, the interest profile determination module 406 determines an interest profile for a client user. The client user's interest profile is defined by a set of interest classifiers that includes individual interest classifiers assigned for each classification category. The interest classifier assigned for a given category indicates the respective client user's level of interest for the given classification category. For example, a client user in the early stages of the purchasing process that is undecided on destination, dates, purpose and budget of the vacation may be assigned an interest classifier of“undecided” for each classification category. As another example, a client user that has decided to take a vacation for the purposes of skiing may be assigned an interest classifier of “skiing” for the interest category “purpose,” while being assigned “undecided” for the interest categories “destination,” “time,” and “budget.” As the client user progresses through the purchase process, the interest classifiers assigned to the client user are updated to reflect changes in the client user's interest profile based on the interest categories.

The interest profile determination module 406 uses profile data for the client user as input into the set of interest extraction models generated by the machine learning model generation module 404. That is, the interest profile determination module 406 uses the client user's profile data as input into the interest extraction model for each interest category. For example, the interest profile determination module 406 uses the client user's profile data as input into an interest extraction model corresponding to the interest category “destination” to determine the interest classifier for the interest category “destination.” As another example, the interest profile determination module 406 uses the client user's profile data as input into an interest extraction model corresponding to the interest category “budget” to determine the interest classifier for the interest category “budget.”

Using the profile data as input in an input extraction model results in a set of probability values indicating the estimated likelihood that each predetermined interest classifier for the interest category properly classifies the client user's interest level in the interest category. The interest profile determination module 406 uses the resulting probability values to select an interest classifier to assign to the client user for the interest category. For example, the interest profile determination module 406 selects the interest classifier with the highest assigned probability value. To accomplish this, the interest profile determination module 406 may rank the interest classifiers based on their assigned probability values from the interest classifier with the highest probability value the interest classifier with the lowest probability value. The interest profile determination module 406 may then select the highest ranked interest classifier.

The interest profile determination module 406 determines the interest profile for a client user based on a time schedule and/or in response to detecting certain events or activity. This includes initially determining the interest profile for the client user as well as determining an updated interest profile for the client user. For example, the interest profile determination module 406 may determine the interest profile for the client user based on a time schedule, such as every day, 2 days, week, and so forth. As another example, the interest profile determination module 406 may determine the interest profile of the client user in response to the client user performing certain actions, such as accessing the online marketplace system 124 website, selecting content items, and the like.

At operation 504, the content selection module 408 selects a content item for the client user based on the interest profile. A content item is any type of content meant to encourage the client user to purchase or book services listed by the online marketplace system 124. For example, the content items may be banner advertisements, images, videos, audio, or the like, that encourage the user to purchase or book services listed by the online marketplace system 124.

The content selection module 408 selects content items from a library of available content items. The content items included in the library of available content items may be of varying levels of specificity. For example, some content items may be general in nature such that they encourage the client user to book a vacation generally without identifying a specific vacation destination, dates, product, and so forth. An example of this type of content item may generally discuss or promote vacations as being fun or relaxing. Some content items may be more specific in nature such that that they encourage a client user to purchase a specific product or service, such as by identifying a specific destination, dates, hotel, activity, or the like.

The content selection module 408 selects content items for a client user based on the client user's interest profile. For example, the content selection module 408 uses the client user's interest profile as input into a content recommendation model. The content recommendation model outputs probability values for content items in the content item library based on the input interest profile. Each probability value indicates an estimated likelihood that the corresponding content item will be successful in eliciting a desired response from the client user, such as the client user selecting the content item to access the online marketplace system 124 website, booking a vacation, completing a purchase, and so forth.

At operation 506, the content delivery module 410 causes presentation of the content item to the client user. The content delivery module 410 causes presentation of the content items selected by the content selection module 408 to the client user. For example, the content delivery module 410 causes the content items to be presented to the client users via one or more other channels that are separate from the online marketplace system 124. For example, the content delivery module 410 may transmit a content item to a client user through a channel that communicates directly with the client user, such as via email or direct message. As another example, the content delivery module 410 may present a content item to the client user through a third-party channel, such as an advertisement (e.g., banner advertisement) presented to the client user on a third-party website.

The content items may be interactive such that a client user may interact with the content item to be directed to the online marketplace system 124 website. For example, the content item may include a selectable portion, which the client user may click, tap or otherwise actuate to cause the client user's client device 110 to navigate to a landing webpage of the online marketplace system 124. As explained earlier, the landing provide to the client user may be personalized to include product recommendations selected for the client user.

At operation 508, the online marketplace system 124 receives a request to access the online marketplace system 124 originating from the content item. For example, the request originated from a web client 112 or client application 114 executing on the client device 110 of the client user as a result of the client user clicking, selecting, or otherwise actuating the content item presented on a display of the client device 110.

At operation 510, the product recommendation selection module 412 selects a product recommendation based on the interest profile and the content item. The product recommendation selection module 412 selects product recommendations to include in a personalized landing page for a client user. A product recommendation is a service associated with a listing posted to the online marketplace system 124. For example, a product recommendation may be lodging, travel, activity, or the like, that a client user may book through the online marketplace system 124.

The product recommendation selection module 412 selects product recommendations for a client user from a library of available product recommendations based on a client user's interest profile and content items presented and/or selected by the client user (e.g., the content item selected by the client user to cause navigation to the online marketplace system 124 website). The product recommendation selection module 412 uses the client user's interest profile and content items presented and/or selected by the client user as input into a product recommendation model that outputs probability values for product recommendations from the library of available product recommendations. Each probability value indicates an estimated likelihood that the corresponding product recommendation will be successful in eliciting a desired response from the client user, such as the client user selecting the product recommendation or purchasing the corresponding product. The product recommendation selection module 412 selects product recommendations to include in the personalized landing page generated for the client user based on the probability values assigned by the product recommendation selection model. For example, the product recommendation selection module 412 selects one or more product recommendations with the highest probability values. As another example, the product recommendation selection module 412 may select one or more product recommendations from varying product categories (e.g., lodging, activities, travel, etc.) that have the highest probability values for that given product category.

At operation 512, the landing page generation module 414 generates a personalized landing page including the product recommendation. The landing page generation module 414 generates a personalized landing page for a client user based on the product recommendations selected by the product recommendation selection module 412. The landing page is a webpage presented to the client user when the user accesses the online marketplace system 124 website through the internet or use of a client-side application 114. The landing page generation module 414 generates the personalized landing page to prominently present listings for the product recommendations selected by the product recommendation selection module 412. Accordingly, when the client user navigates to the online marketplace system 124 website or accesses the online marketplace via a client-side application 114, the client user will be presented with the personalized landing page including listings that are relevant and of interest to the user.

At operation 514, the output module 416 causes presentation of the personalized landing page to the client user. For example, the output module 416 transmits code defining the personalized landing page to the client device 110 used by the client user to request access to the online marketplace system 124. The client device 110 uses the received code to cause presentation of the landing page to the client user. For example, the personalize landing page is presented on a display of the client device 110 as a webpage generated by the web client 112 or as an initial page presented by the client application 114.

### Software Architecture

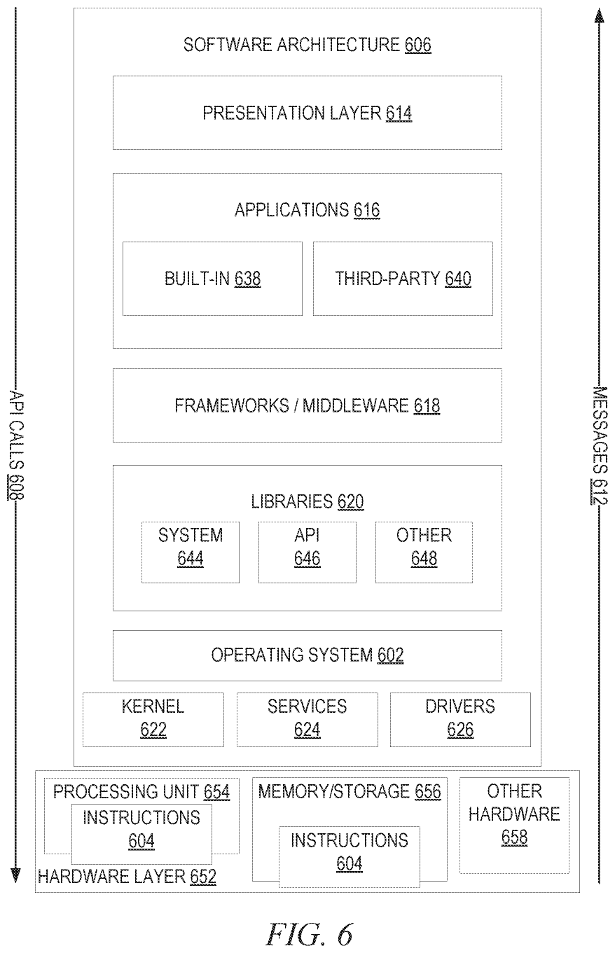

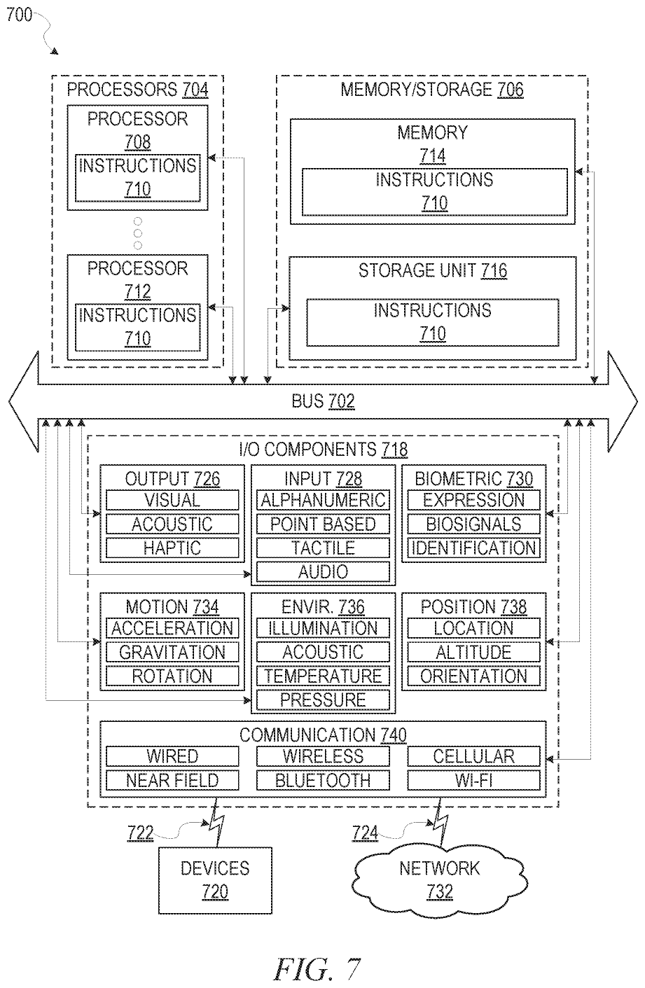

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
determining a first interest classifier for a first user account of an online marketplace system, the first interest classifier determined using profile data of the first user account as input into a first interest extraction model, the first interest extraction model having been trained using labeled training profile data from multiple user accounts of the online marketplace system;
selecting a first content item for the first user account based on at least the first interest classifier;
causing presentation of a first content item from the set of content items on a client device associated with the first user account, the first content item presented via a first channel that is separate from the online marketplace service;
receiving, from the client device, a request to access the online marketplace system, the request originated from the first content item presented on the client device;
selecting at least a first product recommendation based on the first interest classifier and the first content item;
generating a landing webpage of the online marketplace system, the landing webpage including the first product recommendation; and
causing presentation of the landing webpage on the client device.

2. The method of claim 1, wherein the first interest classifier is determined from a first set of predetermined interest classifiers for a first category and the labeled training profile data corresponding to each user account from the multiple user accounts is labeled with at least one of the interest classifiers from the first set of predetermined interest classifiers for the first category.

3. The method of claim 2, further comprising:
determining a second interest classifier for the first user account, the second interest classifier determined using profile data of the first user account as input into a second interest extraction model, the second interest extraction model having been trained using the labeled training profile data from multiple user accounts of the online marketplace system, wherein the first content item is selected based on at least the first interest classifier and the second interest classifier.

4. The method of claim 3, wherein the second interest classifier is determined from a second set of predetermined interest classifiers for a second category and the labeled training profile data corresponding to each user account from the multiple user accounts is also labeled with at least one of the interest classifiers from the second set of predetermined interest classifiers for the second category.

5. The method of claim 1, further comprising:
selecting a second content item for the first user account based on at least the first interest classifier; and
causing presentation of the second content item from the set of content items on the client device associated with the first user account, the second content item presented via a second channel that is separate from the online marketplace service.

6. The method of claim 5, further comprising:
receiving, from the client device, a subsequent request to access the online marketplace system, the subsequent request originated from the second content item presented on the client device;
selecting at least a second product recommendation based on the first interest classifier, the first content item and the second content item;
generating a second landing webpage of the online marketplace system, the second landing webpage including the second product recommendation; and
causing presentation of the second landing webpage on the client device.

7. The method of claim 1, wherein the first content item is selected using the first interest classifier as input into a content recommendation model and the first product recommendation is selected using the first interest classifier and the first content item as input into a product recommendation model.

8. A system comprising:
one or more computer processors; and
one or more computer-readable mediums storing instructions that, when executed by the one or more computer processors, cause the system to perform operations comprising:
determining a first interest classifier for a first user account of an online marketplace system, the first interest classifier determined using profile data of the first user account as input into a first interest extraction model, the first interest extraction model having been trained using labeled training profile data from multiple user accounts of the online marketplace system;
selecting a first content item for the first user account based on at least the first interest classifier;
causing presentation of a first content item from the set of content items on a client device associated with the first user account, the first content item presented via a first channel that is separate from the online marketplace service;
receiving, from the client device, a request to access the online marketplace system, the request originated from the first content item presented on the client device;
selecting at least a first product recommendation based on the first interest classifier and the first content item;
generating a landing webpage of the online marketplace system, the landing webpage including the first product recommendation; and
causing presentation of the landing webpage on the client device.

9. The system of claim 8, wherein the first interest classifier is determined from a first set of predetermined interest classifiers for a first category and the labeled training profile data corresponding to each user account from the multiple user accounts is labeled with at least one of the interest classifiers from the first set of predetermined interest classifiers for the first category.

10. The system of claim 9, the operations further comprising:
determining a second interest classifier for the first user account, the second interest classifier determined using profile data of the first user account as input into a second interest extraction model, the second interest extraction model having been trained using the labeled training profile data from multiple user accounts of the online marketplace system, wherein the first content item is selected based on at least the first interest classifier and the second interest classifier.

11. The system of claim 10, wherein the second interest classifier is determined from a second set of predetermined interest classifiers for a second category and the labeled training profile data corresponding to each user account from the multiple user accounts is also labeled with at least one of the interest classifiers from the second set of predetermined interest classifiers for the second category.

12. The system of claim 8, the operations further comprising:
selecting a second content item for the first user account based on at least the first interest classifier; and
causing presentation of the second content item from the set of content items on the client device associated with the first user account, the second content item presented via a second channel that is separate from the online marketplace service.

13. The system of claim 12, the operations further comprising:
receiving, from the client device, a subsequent request to access the online marketplace system, the subsequent request originated from the second content item presented on the client device;
selecting at least a second product recommendation based on the first interest classifier, the first content item and the second content item;
generating a second landing webpage of the online marketplace system, the second landing webpage including the second product recommendation; and
causing presentation of the second landing webpage on the client device.

14. The system of claim 8, wherein the first content item is selected using the first interest classifier as input into a content recommendation model and the first product recommendation is selected using the first interest classifier and the first content item as input into a product recommendation model.

15. A non-transitory computer-readable medium storing instructions that, when executed by one or more computer processors of one or more computing devices, cause the one or more computing devices to perform operations comprising:
determining a first interest classifier for a first user account of an online marketplace system, the first interest classifier determined using profile data of the first user account as input into a first interest extraction model, the first interest extraction model having been trained using labeled training profile data from multiple user accounts of the online marketplace system;
selecting a first content item for the first user account based on at least the first interest classifier;
causing presentation of a first content item from the set of content items on a client device associated with the first user account, the first content item presented via a first channel that is separate from the online marketplace service;
receiving, from the client device, a request to access the online marketplace system, the request originated from the first content item presented on the client device;
selecting at least a first product recommendation based on the first interest classifier and the first content item;
generating a landing webpage of the online marketplace system, the landing webpage including the first product recommendation; and
causing presentation of the landing webpage on the client device.

16. The non-transitory computer-readable of claim 15, wherein the first interest classifier is determined from a first set of predetermined interest classifiers for a first category and the labeled training profile data corresponding to each user account from the multiple user accounts is labeled with at least one of the interest classifiers from the first set of predetermined interest classifiers for the first category.

17. The non-transitory computer-readable of claim 16, the operations further comprising:
determining a second interest classifier for the first user account, the second interest classifier determined using profile data of the first user account as input into a second interest extraction model, the second interest extraction model having been trained using the labeled training profile data from multiple user accounts of the online marketplace system,
wherein the second interest classifier is determined from a second set of predetermined interest classifiers for a second category and the labeled training profile data corresponding to each user account from the multiple user accounts is also labeled with at least one of the interest classifiers from the second set of predetermined interest classifiers for the second category, and
wherein the first content item is selected based on at least the first interest classifier and the second interest classifier.

18. The non-transitory computer-readable medium of claim 15, the operations further comprising:
selecting a second content item for the first user account based on at least the first interest classifier; and
causing presentation of the second content item from the set of content items on the client device associated with the first user account, the second content item presented via a second channel that is separate from the online marketplace service.

19. The non-transitory computer-readable medium of claim 18, the operations further comprising:
receiving, from the client device, a subsequent request to access the online marketplace system, the subsequent request originated from the second content item presented on the client device;
selecting at least a second product recommendation based on the first interest classifier, the first content item and the second content item;
generating a second landing webpage of the online marketplace system, the second landing webpage including the second product recommendation; and
causing presentation of the second landing webpage on the client device.

20. The non-transitory computer-readable medium of claim 15, wherein the first content item is selected using the first interest classifier as input into a content recommendation model and the first product recommendation is selected using the first interest classifier and the first content item as input into a product recommendation model.
